(19) United States
(12) Patent Application Publication
(10) Pub. No.: US 2024/0353935 A1
(43) Pub. Date: Oct. 24, 2024

(54) KEYBOARD

(71) Applicant: ACCO Brands Corporation, Lake Zurich, IL (US)

(72) Inventors: Alex J. Klinkman, Patterson, CA (US); Po-Ming Hsu, New Taipei City (TW); Yu-Chia Huang, New Taipei City (TW); Sung-Chen Lu, New Taipei City (TW)

(21) Appl. No.: 18/306,069

(22) Filed: Apr. 24, 2023

(51) Int. Cl. G06F 3/02; G06F 3/023

(52) U.S. Cl. CPC G06F 3/0227; G06F 3/0202; G06F 3/023

(57) ABSTRACT

A keyboard for use with an electronic device including an electronic processor. The keyboard includes a printed circuit board that is configured to communicate with the electronic processor of the electronic device, a first plurality of physical keys, and a second plurality of dedicated physical keys. Each of the first plurality of physical keys is movable between an unactuated position and an actuated position. When in the actuated position, each of the first plurality of physical keys is configured to generate a first signal that inserts a character on the electronic device. Each of the second plurality of dedicated physical keys is movable between an unactuated position and an actuated position. When in the actuated position, each of the second plurality of dedicated physical keys is configured to generate a second signal that performs a function in a teleconferencing application running on the electronic device.

### FIELD OF THE INVENTION

The present invention relates to a keyboard for use with an electronic device.

### SUMMARY

In one embodiment, the invention provides a keyboard for use with an electronic device including an electronic processor. The keyboard includes a printed circuit board that is configured to communicate with the electronic processor of the electronic device, a first plurality of physical keys, and a second plurality of dedicated physical keys. Each of the first plurality of physical keys is movable between an unactuated position and an actuated position. When in the actuated position, each of the first plurality of physical keys is configured to generate a first signal that inserts a character on the electronic device. Each of the second plurality of dedicated physical keys is movable between an unactuated position and an actuated position. When in the actuated position, each of the second plurality of dedicated physical keys is configured to generate a second signal that performs a function in a teleconferencing application running on the electronic device.

In another embodiment, the invention provides a keyboard for use with an electronic device. The electronic device includes an electronic processor. The keyboard includes a printed circuit board including a controller and a plurality of physical teleconferencing keys. Each of the plurality of physical teleconferencing keys is movable between an unactuated position and an actuated position. In the actuated position each of the plurality of physical teleconferencing keys is configured to generate a signal. The controller is configured to receive the signal from each of the plurality of physical teleconferencing keys when each of the plurality of physical teleconferencing keys is actuated, and send the signal to the electronic device to perform a function in a teleconferencing application of the electronic device while the teleconferencing application is running in a background of the electronic device.

In another embodiment, the invention provides a non-transitory, computer-readable medium storing instructions that, when executed by an electronic processor, perform a set of functions. The set of functions include receiving a signal from a plurality of physical teleconferencing keys of a keyboard when each of the plurality of physical teleconferencing keys is actuated, sending the signal to a teleconferencing application running on electronic device while the teleconferencing application is running in a background of the electronic device, and actuating a function in the teleconferencing application associated with the actuated physical teleconferencing key.

In another embodiment, the invention provides a keyboard for use with an electronic device. The keyboard includes a housing that has a first housing portion and a second housing portion coupled to the first housing portion. A switch support is positioned within the housing and includes a plurality of apertures extending therethrough. A printed circuit board is supported by the switch support and is accessible via the plurality of apertures of the switch support. A plurality of switches is supported by the switch support. Each of the plurality of switches is accessible through one of the plurality of apertures in the switch support and includes a contact pin in contact with printed circuit board. An elastic member is supported by the switch support. The elastic member includes a plurality of openings. Each of the plurality of openings corresponds to one of the plurality of apertures in the switch support. The keyboard also includes a plurality of key caps. Each key cap includes a shell and a projection extending from the shell through the first housing portion. The projection of each key cap engages one of the plurality of switches to move the switch between an unactuated position, in which the contact pin is not in communication with the circuit board, and an actuated position, in which the contact pin is in communication with the printed circuit board. A portion the elastic member is positioned between each of switch and the shell of each key cap to inhibit fluid from contacting the printed circuit board and to reduce a sound emitted when the shell of each key cap moves to the actuated position.

Other aspects of the invention will become apparent by consideration of the detailed description and accompanying drawings.

### BRIEF DESCRIPTION OF THE DRAWINGS

FIG. 1 is a perspective view of a keyboard according to one embodiment including a housing and keys.

FIG. 2 is a bottom view of the keyboard of FIG. 1.

FIG. 3A is an exploded view of the keyboard of FIG. 1 illustrating the housing, an elastic member, and a switch assembly.

FIG. 3B is another exploded view of the elastic member and a portion of the switch assembly of FIG. 1.

FIG. 4A is a perspective view of one of the keys of FIG. 1.

FIG. 4B is a perspective view of one of the keys of FIG. 1 with a cutaway portion removed.

FIG. 5 is a bottom view of the of the elastic member and the portion of the switch assembly of FIG. 3B.

FIG. 6A is a cross-sectional view of the keyboard of FIG. 1 along the line 6A-6A of FIG. 1.

FIG. 6B is a detailed cross-sectional view of a portion of the keyboard of FIG. 1 along the line 6A-6A of FIG. 1.

FIG. 6C is a cross-sectional view of the keyboard of FIG. 1 along the line 6C-6C of FIG. 1.

FIG. 7 is a cross-sectional view of the keyboard of FIG. 1 along the line 7-7 of FIG. 2.

FIG. 8 is a block diagram of the keyboard of FIG. 1 and an electronic device for use with the keyboard.

FIG. 9 is a block diagram of an application of the electronic device.

FIG. 10 illustrates an exemplary method of using the keyboard of FIG. 1 to perform a function.

FIG. 11 illustrates an exemplary method of using an application running on the electronic device and in communication with the keyboard of FIG. 1.

FIG. 12 illustrates an exemplary graphical user interface of an application for use with the keyboard of FIG. 1.

FIG. 13 illustrates another exemplary graphical user interface of the application for use with the keyboard of FIG. 1.

FIG. 14 illustrates another exemplary graphical user interface of the application for use with the keyboard of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

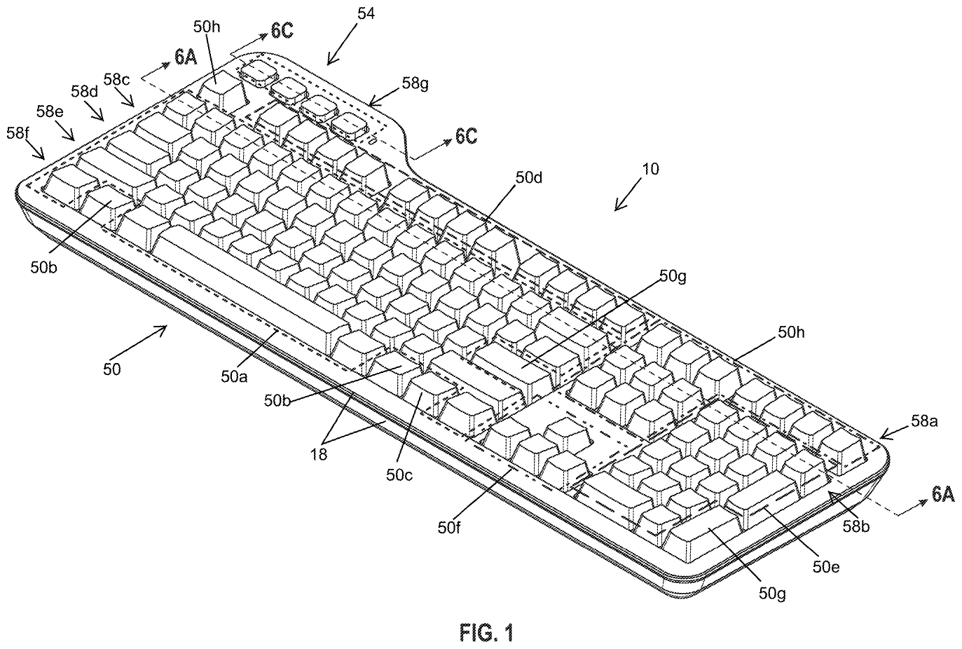

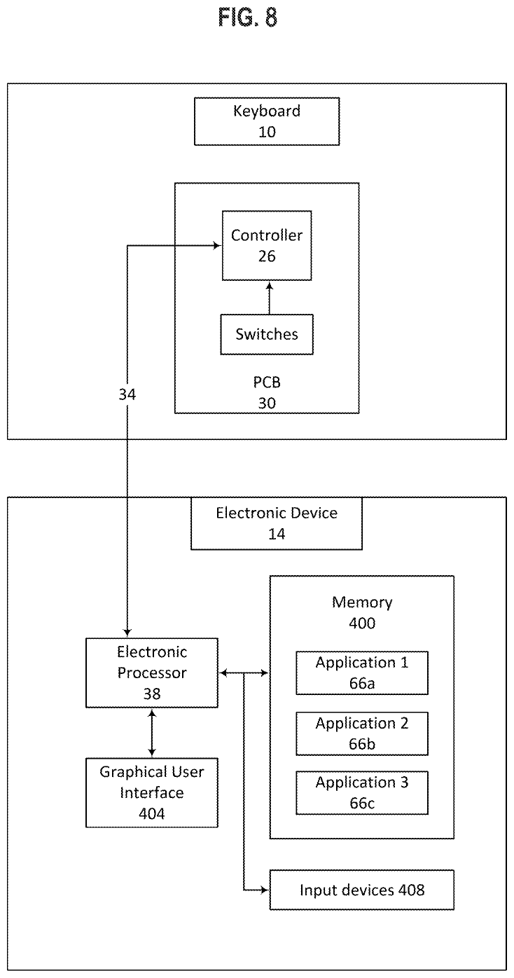

FIG. 1 illustrates a keyboard 10 for use with an electronic device 14, such as a personal computer, a laptop computer, a tablet computer, a smart phone, etc. In the illustrated embodiment, the keyboard 10 includes a housing 18, a plurality of physical keys 50, 54, and a printed circuit board 30 (FIG. 8). Each of the plurality of physical keys is configured to generate and send signals to a controller 26 of the printed circuit board 30. The controller 26 may be an electronic controller, a microprocessor, a microcontroller, a Bluetooth transceiver, or other suitable device. The controller 26 of the keyboard 10 is configured to wirelessly communicate with a receiver 34 (e.g., a USB receiver, FIG. 8) that is in electrical communication with an electronic processor 38 of the electronic device 14. In other embodiments, the controller 26 of the keyboard 10 may be configured to communicate with the electronic device 14 with a wired connection 34.

With respect to FIG. 1, the keys are organized into a first plurality of keys 50 and a second plurality of keys 54.

The first plurality of keys 50 are standard or conventional keys. In the illustrated embodiment, the standard keys 50 are organized in the standard QWERTY keyboard layout. That is, the standard keys 50 are organized into six rows. In the embodiment of FIG. 1, within these six rows 58a-58f, the standard keys 50 are generally organized into the standard sections: typewriter keys 50a (e.g., that insert characters to the electronic device), system keys 50b, application key 50c (e.g., a Windows® key or a Command key), function keys 50d, numeric keypad keys 50e, cursor control keys 50f, Enter keys 50g, and other keys 50h (which may include Escape, Insert, Delete, Home, End, Page Up, Page Down, Number Lock, Caps Lock, etc.). In other embodiments (FIG. 11-13) the numeric keypad keys 50e and several of the other keys 50h may be omitted.

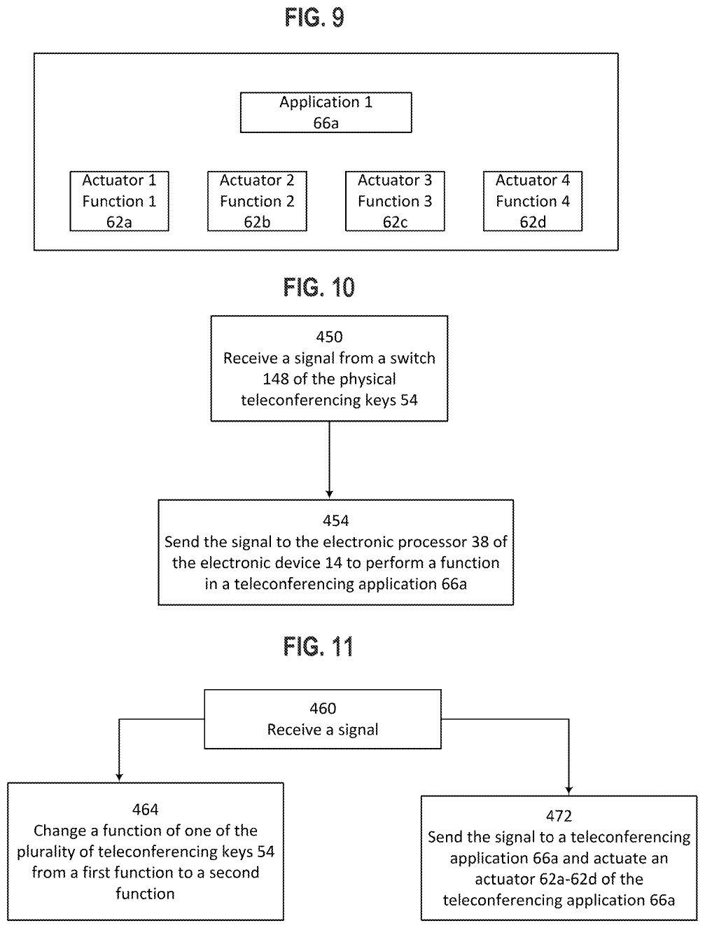

The second plurality of keys 54 are physical teleconferencing keys. The second plurality of keys 54 are also dedicated teleconferencing keys. The term dedicated, as used herein, means that keys are configured during manufacture of the keyboard 10 to control a teleconferencing application running on an electronic device. When dedicated, the teleconferencing keys 54 only output signals associated with the teleconferencing application. Unlike, for example, the function keys 50d, the teleconferencing keys 54 are not usable to output other commands associated with other applications, unless specifically reprogrammed (as described below). The teleconferencing keys 54 are spaced apart from the standard keys 50. In the illustrated embodiment, the teleconferencing keys 54 are in a separate row 58g (e.g., a seventh row) that is adjacent to the first row 58a (e.g., top-most row) of the standard keys 50. In other embodiments, the teleconferencing keys 54 may be located elsewhere relative to the standard keys 50. For example, the teleconferencing keys 54 may be located to the side of the standard keys 50 or may be located below the sixth row (e.g., lower-most row) of the standard keys. Alternatively, the teleconferencing keys 54 may be located between sections of the standard keys 50 (e.g., between the typewriter keys 50a and the numeric keypad keys 50c). In some embodiments, the teleconferencing keys 54 may be arranged in a column or a grid (e.g., a 2×2 square), and/or the teleconferencing keys 54 may include fewer or more than four keys. The teleconferencing keys 54 are operable to control actuators 62a-62d of a teleconferencing application 66a (FIGS. 8 and 9) that is loaded onto the electronic device 14, as will be discussed in greater detail below.

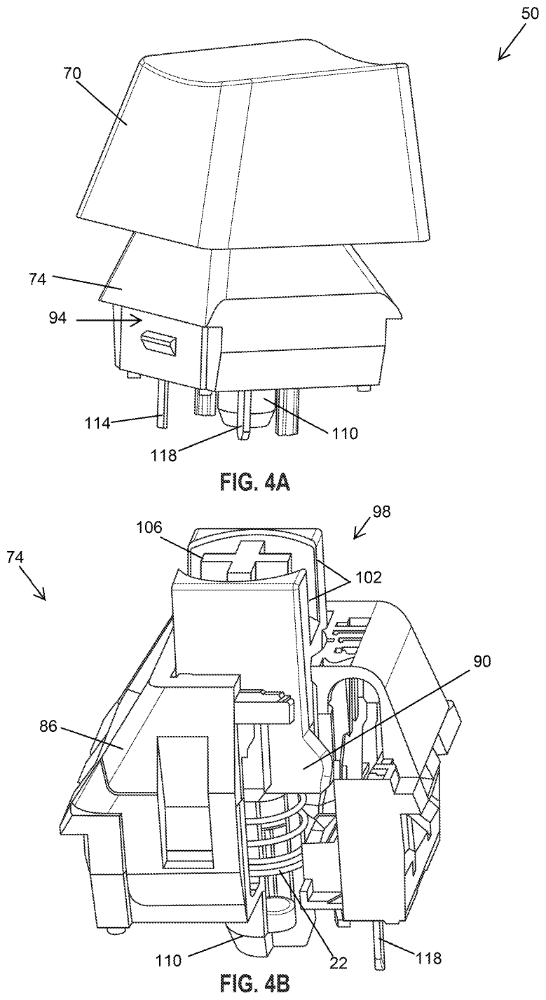

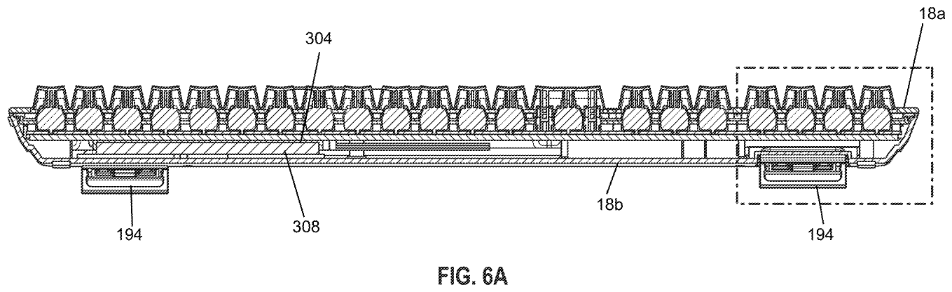

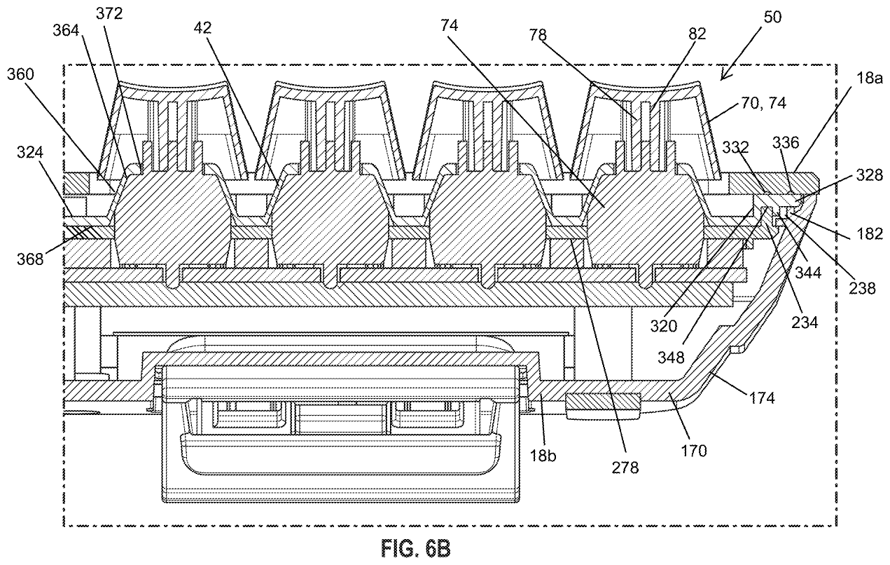

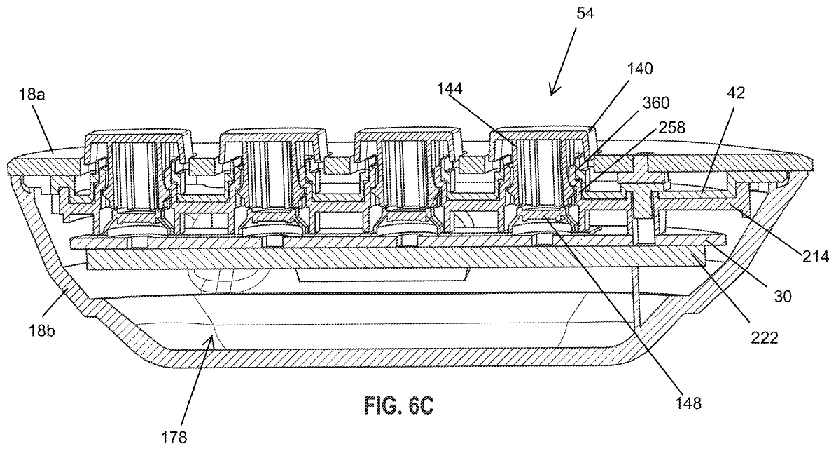

Turning to FIGS. 4A, 4B, and 6B, each of the standard keys 50 includes a key cap 70 that is configured to actuate a corresponding key switch 74. As shown in FIG. 6B, the key caps 70 each include a shell 74, a projection 78 extending from an inner surface of the shell 74, and a bore 82 defined within the projection 78.

As shown in FIG. 4B, the key switches 74 each include a switch housing 86 and a stem 90 movably supported by the switch housing 86. The switch housing 86 includes a first end and a second end opposite the first end. The switch housing 86 has a slot 94 (FIG. 4A) defined on opposite sides thereof, although only one of which is shown. As shown in FIG. 4B, the stem 90 includes a keystroke 98 extending through and from the first end of the switch housing 86. The keystroke 98 includes an outer wall 102 and a projection 106 positioned within the outer wall 102. The projection 106 is complementary to the bore 82 of the key cap 70. The switch housing 86 includes a guide 110 extending from the second end. The switch housing 86 also supports a pair of contact pins 114, 118 (FIG. 4A), which contact the PCB 30. A first end (not shown) of each of the contact pins 114, 118 is positioned within the respective switch housing and a second end extends from the second end of the switch housing 86.

As shown in FIG. 6B, the projection 106 of the stem 90 is received in the bore 82 of the key cap 70, and the projection 78 of key cap 70 is seated within the outer wall 102 of the stem 90. The stem 90 is biased into an unactuated position by a spring 122 (FIG. 4B) in which the first ends of the pair of contact pins 114, 118 are disengaged from one another. A force exerted on the key cap 70 will move the key switch 74 from the unactuated position to an actuated position against the bias of the spring 122. In the actuated position, the stem 90 moves relative to the switch housing 86 to enable electrical communication between the first ends of the contact pins 114, 118.

With respect to FIG. 6C, the teleconferencing keys 54 have a different structure. That is, the teleconferencing keys 54 each include a key cap 140 with a projection 144 that directly actuates a switch 148, which is positioned on and in communication with the PCB 30. Accordingly, the teleconferencing keys 54 are movable between an unactuated position in which the projection 144 is disengaged from a corresponding switch 148 and an actuated position in which the projection 144 is engaged with the corresponding switch 148. The key caps 140 of the teleconferencing keys 54 are biased into the unactuated position, and a force on the key cap 140 moves the respective teleconferencing key 54 to the actuated position. In other embodiments, the teleconferencing keys 54 may have the same structure as the standard keys 50.

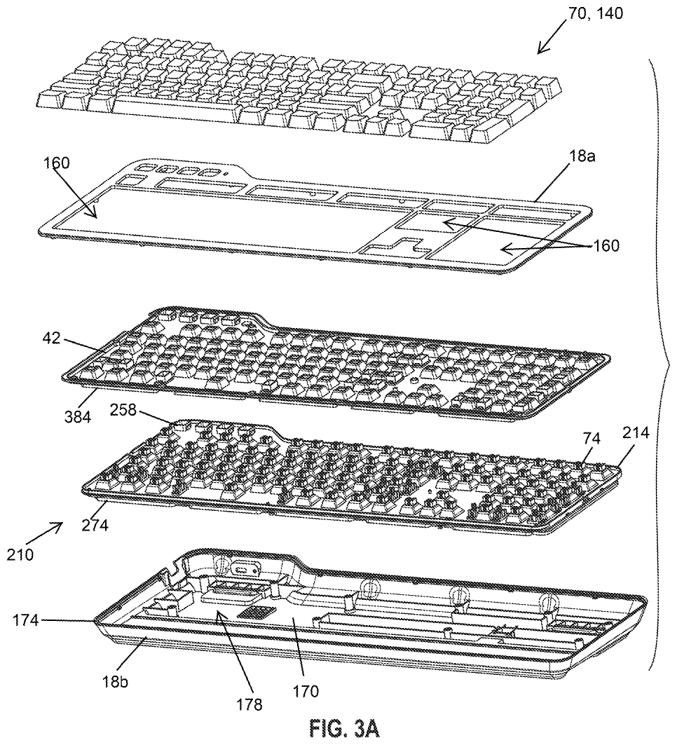

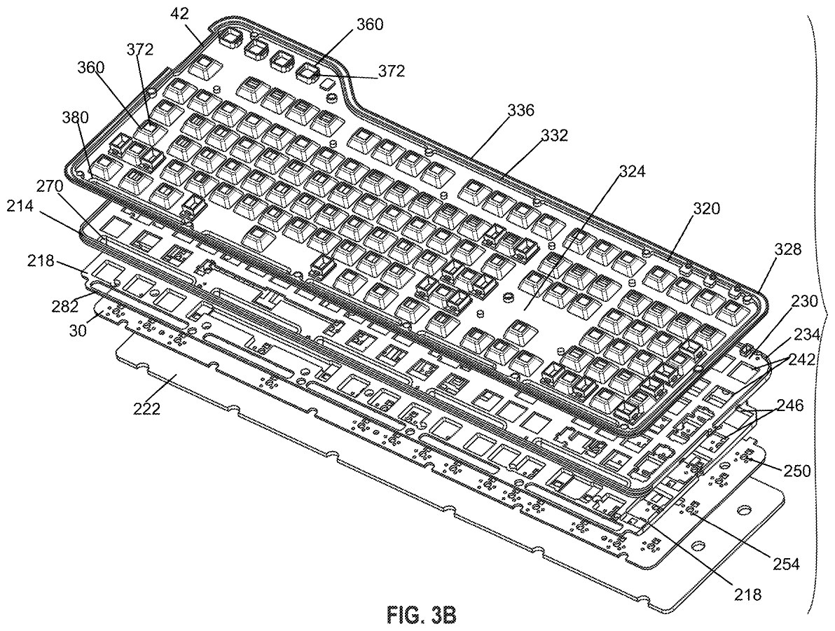

As will be discussed below, and as generally shown in FIG. 3A, the illustrated keyboard 10 also has an elastic member 42 that is configured to help make actuation of the keys 50, 54 quieter and to inhibit fluid from reaching the printed circuit board 30.

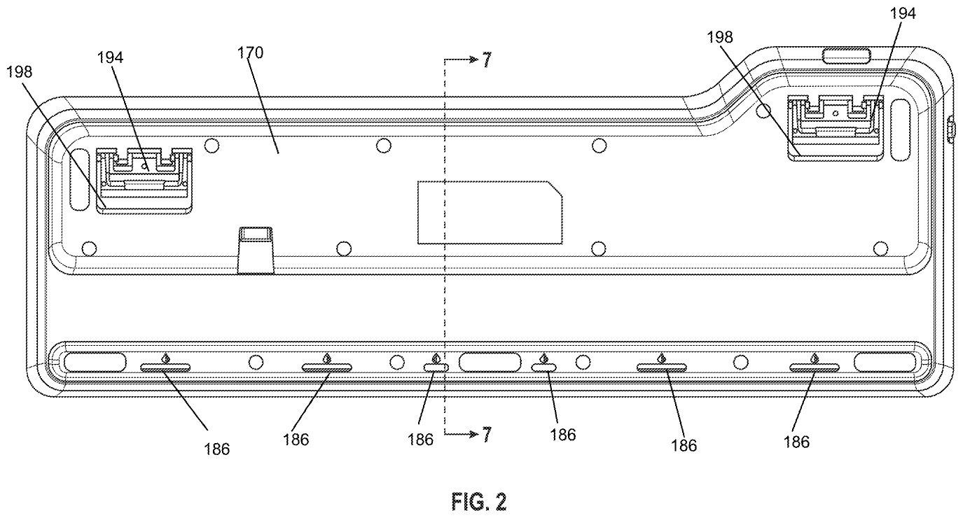

With respect to FIGS. 1 and 2, the housing 18 includes a first side, a second side opposite the first side, a first housing portion 18a, and a second housing portion 18b. The first housing portion 18a is supported by the second housing portion 18b and includes a plurality of apertures 160. The key caps 70, 140 are accessible through the apertures 160 in the first housing portion 18a.

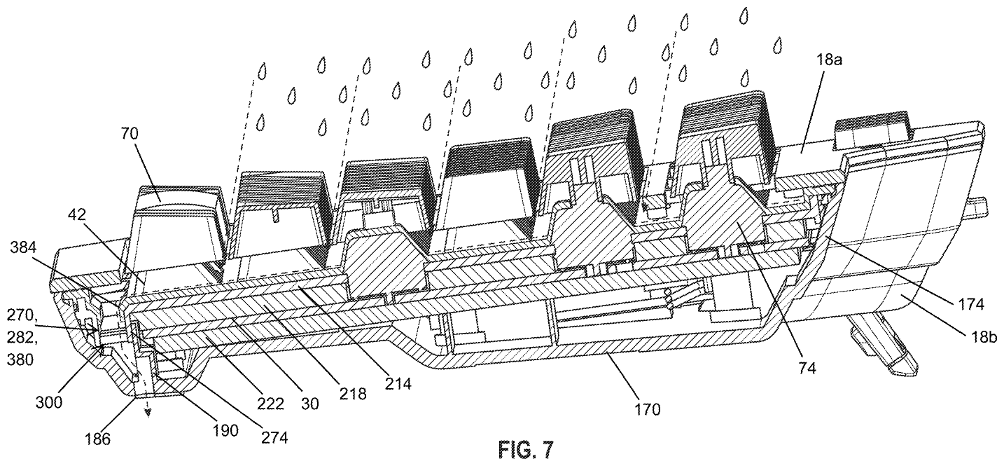

With respect to FIG. 3A, the second housing portion 18b has a bottom wall 170, an outer wall 174 extending from the bottom wall 170, and a recess 178 defined by the bottom and outer walls 170, 174. The outer wall 174 defines a perimeter. A ledge 182 (FIG. 6B) is defined about the perimeter. The ledge 182 is spaced apart from and recessed relative to the outer wall 174. The second housing portion 18b has a plurality of drain holes 186 (FIG. 2) adjacent to the second side and extending through the bottom wall 170. As shown in FIG. 7, the second housing portion 18b includes an inner wall 190 that separates one or more of the drain holes 186 from the remainder of the recess 178. An inner wall 190 may separate each of the drain holes 186 from the recess 178 and/or may separate more than one drain hole 186 from the recess 178.

Also, a pair of legs 194 (FIGS. 2 and 6A) are movably coupled to the bottom wall 170. In the illustrated embodiment, the legs 194 are movable or pivotable between a closed position and an open position. In the closed position, the legs 194 are received in a corresponding recess 198 such that a surface of each of the legs 194 is flush with or recessed relative to the second housing portion 18b. When in the closed position, the bottom wall 170 (with foot pads) supports the housing 18 on a support surface (e.g., a table or desk). In the open position (shown herein), the legs 194 project from the bottom wall 170 and are configured to support a portion of the housing 18. When the legs 194 are in the open position, the first side of the housing 18 is elevated relative to the second side of the housing 18.

With respect to FIGS. 3A, 6A, and 6B, positioned within the housing 18 is a switch support assembly 210 that supports the key switches 74. The switch support assembly 210 is supported by the first housing portion 18a and second housing portion 18b. In the illustrated embodiment, the switch support assembly 210 includes a first or upper switch support 214, a second or intermediate switch support 218, the PCB 30, and a third or lower switch support 222. The upper switch support 214 is coupled via fasteners (not shown) to the first housing portion 18a. The lower switch support 222 is coupled via fasteners (not shown) to the second housing portion 18b. The intermediate switch support 218 and the PCB 30 are positioned between the upper switch support 214 and the lower switch support 222. The switch support assembly 210 is configured to position the PCB 30 at least partially above an inner surface of the bottom wall 170 of the second housing portion 18b.

With respect to FIG. 3B, the upper switch support 214 includes a wall 230 that extends from an upper surface 234 thereof. The wall 230 extends about a perimeter of the upper switch support 214. As shown in FIG. 6B, the wall 230 is positioned inwardly of the ledge 182 of the second housing portion 182 such that a groove 238 is defined therebetween. The upper switch support 214 also includes plurality of apertures 242. The intermediate switch support 218 also includes a plurality of apertures 246. Each of the apertures 246 of the intermediate switch support 218 correspond to one of the apertures 242 of the upper switch support 214. Like the keys 50, 54, the apertures 242, 246 of the upper switch support 214 and the intermediate switch support 218 are arranged in the six standard rows for the standard keys 50 and a seventh row for the teleconferencing keys 54.

As shown in FIGS. 6A and 6B, each of the aligned apertures 242, 246 of the standard rows are configured to receive the switch housing 86 of a corresponding key switch 74. The upper switch support 214 is configured to be received in the pair of slots 94 of the switch housing 54. As shown in FIG. 6B, the guide 110 of each key switch 74 extends through apertures 250 in the PCB 30 and is supported by the lower support member 222. Although not shown in detail, the contact pins 114, 118 are each positioned within apertures 254 of the PCB 30. The contact pins 114, 118 are configured to be in communication with the controller 26 when the stem 90 is in the actuated position.

As shown in FIGS. 3A and 6C, each of the aligned apertures 242, 246 of the seventh row includes a rib 258 that extends from the upper surface 230 of the upper switch support 214. The rib 258 is configured to receive the projection 144 of the key caps 140 of the teleconferencing keys 54. As noted above, the switches 148 are positioned on the PCB 30 below the respective aligned apertures 242, 246 and projections 144.

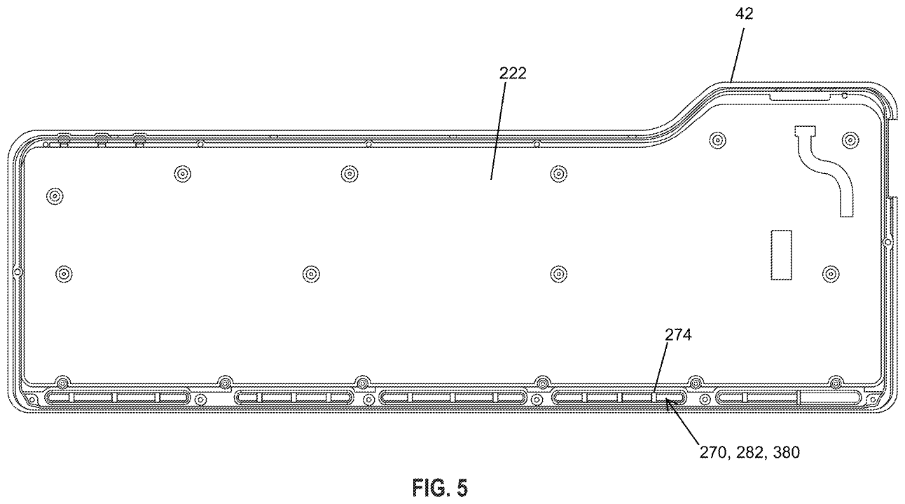

In the illustrated embodiment, as shown in FIGS. 3B, the upper support member 214 includes drain holes 270 that extend along the second side of the housing 18. The drain holes 270 are enclosed by a rib 274 (FIG. 3A) that extends from a lower surface 278 of the upper switch support 214. Each of the ribs 274 extends through a corresponding drain hole 282 in the intermediate switch support 218. As shown in FIG. 5, a width of the upper switch support 214 and the intermediate switch support 218 is greater than a width of the PCB 30 and lower switch support 222. Accordingly, the aligned drain holes 270, 282 are positioned outside of the perimeter of the PCB 30 and the lower switch support 222. With respect to FIG. 7, the inner walls 190 of the second housing portion 18b are configured to engage the intermediate switch support 218. Also, the ribs 274 of the upper switch support 214 extend past a location of engagement between the second housing portion 18b and the intermediate switch support 218. Accordingly, the switch support assembly 210 and the second housing portion 18b create a drainage channel 300 that is separated from the rest of the recess 178.

Although the upper switch support 214 and intermediate switch support 218 are separate pieces in the illustrated embodiment, in other embodiment the upper switch support 214 and the intermediate switch support 218 may be single unitary piece.

With respect to FIG. 6A, the lower switch support 222 includes a battery holder 304 that is configured to receive and support a battery 308, which powers the controller 26 and PCB 30. In other embodiments, the keyboard 10 may be a wired keyboard and not include the battery 308.

With respect to FIGS. 3A-4 and 6A-7, the elastic member 42 is supported by the switch support assembly 210 and the second housing portion 18b. Moreover, the elastic member 42 is clamped between the first housing portion 18a and the second housing portion 18b.

With respect to FIG. 2B in particular, the elastic member 42 includes a wall 320 that extends from an upper surface 324 and a lip 328 that extends outwardly from the wall 320. The wall 320 and the lip 328 extend about a perimeter of the elastic member 42. The lip 328 includes an upper surface that has a first or inner projection 332 and a second or outer projection 336 extending therefrom. The first projection 332 and the second projection 336 are spaced apart from one another. A third projection 344 extends from a lower surface of the lip 328 and is spaced apart from the wall 320 of the elastic member 42. A lower groove 348 is positioned between the third projection 344 and the wall 320.

A plurality of projections 360 extend from the upper surface 324 of the elastic member 42. Each of the projections 360 defines a recess 364 that is accessible from a lower surface 368 of the elastic member 42. Additionally, each of the projections 360 defines an opening 372.

Like the upper switch support 214, the elastic member 42 includes drain holes 380 positioned adjacent to the second side of the housing 18. The drain holes 380 are enclosed by a rib 384 that extends from the lower surface 368 of the elastic member 42.

When assembled, the elastic member 42 overlays the upper switch support 214 and a portion of each of the key switches 74. For each of the standard keys 50, the switch housing 86 of each of the key switches 74 is at least partially positioned within a recess 364 of the corresponding projection 360 and the keystroke 98 extends through the corresponding opening 372. As shown in FIG. 6B, the clastic member 42 surrounds and contacts at least a portion of the keystroke 98. For each of the teleconferencing keys 54, the projection 360 of the elastic member 42 extends about and beyond each of the ribs 258 of the upper switch support 214, as shown in FIG. 6C. The lower surface 368 of the elastic member 42 contacts the upper surface 324 of the upper switch support 214. Additionally, the drain holes 380 of the elastic member 42 are aligned with the drain holes 270, 282 of the switch support assembly 210. In particular, each of the ribs 384 of the elastic member 42 are received within a corresponding drain hole 270 of the upper switch support 214. That is, each of the ribs 384 of the elastic member 42 is positioned within and abuts a corresponding rib 274 of the upper switch support 214. Accordingly, the drain holes 380 of the clastic member 42 are also positioned outside of the perimeter of the PCB 30 and the lower switch support 222. As shown in FIG. 7, the aligned drain holes 270, 282, 380 of the elastic member 42 and the switch support assembly 210 are in communication with the drain holes 186 in the second housing portion 18b via the drainage channel 300. The lower groove 348 is configured to receive the wall 324 of the upper support 314, while the perimeter of the elastic member 42 is supported by the ledge 182 of the second housing portion 18b. The first and second projections 332, 336 of the elastic member 42 engage a lower surface of the first housing portion 18a. Accordingly, the elastic member 42 is clamped between the first and second housing portions 18a, 18b.

As shown in FIGS. 6A and 7, the elastic member 42 both helps to reduce the amount of sound that is created by actuating the keys 50, 54 and inhibits fluid from reaching the PCB 30. With respect to FIG. 7, when the keyboard encounters fluid, the fluid is directed through the apertures 160 in the first housing portion 18a and guided around the projections 360 of the clastic member 42 to the drainage channel 300 via the aligned drain holes 270, 282, 380 to guide fluid out of the housing 18. Accordingly, the drainage channel 30 inhibits fluid from entering the recess 178 of the second housing portion 18b and reaching the PCB 30. With respect to FIG. 6A, a height between the shell 74 of the key cap 70, 140 and a contact surface (e.g., the elastic member 42) is reduced, as compared to conventional keyboard. Also, the clastic member 42 acts to absorb sound when the shell 74 contacts the same. The reduced height and sound absorbing nature of the elastic member 42 helps to reduce the amount of sound that is created by actuation of the keys 50, 54.

The keys 70, 140, via the switches 74, 148 and the controller 26 of the PCB 30, are configured to communicate with the electronic processor 38 to perform functions on the electronic device 14.

An exemplary electronic device 14 is illustrated in block diagram format in FIG. 8. The electronic device 14 includes the electronic processor 38, a memory 400, a plurality of applications 66a-66c, a graphical user interface 404, and input devices 408 (in addition to the keyboard 10). The electronic processor 38 may be an electronic controller, a microprocessor, a microcontroller, application-specific integrated circuit (ASIC), or other suitable device. The memory 400 may be read only memory (ROM), random access memory (RAM), other non-transitory computer-readable media, or combination thereof. The graphical user interface 404 may include, for example, a touchscreen, a liquid crystal display (“LCD”), a light-emitting diode (“LED”), a LED display, an organic LED (“OLED”) display, an electroluminescent display (“ELD”), and the like. The input devices 408 may include, for example, a keypad, a mouse, a touchscreen (for example, as part of the graphical user interface 404), a microphone, a camera, or the like (not shown). The applications 66a-66c may be loaded to the memory 400 of the electronic device 14 and a user may view and control the application 66a-66c using the display 404. In some embodiments, a communication interface (not shown), such as a transceiver, for communicating over the communication network(s) and, optionally, one or more additional communication networks or connections. The communication interface, if present, allows the electronic device 14 to communicate with a server over the communication network(s). The electronic processor 38, the memory 400, the communication interface, and the graphical user interface 404 communicate wirelessly, over one or more communication lines or buses or a combination thereof.

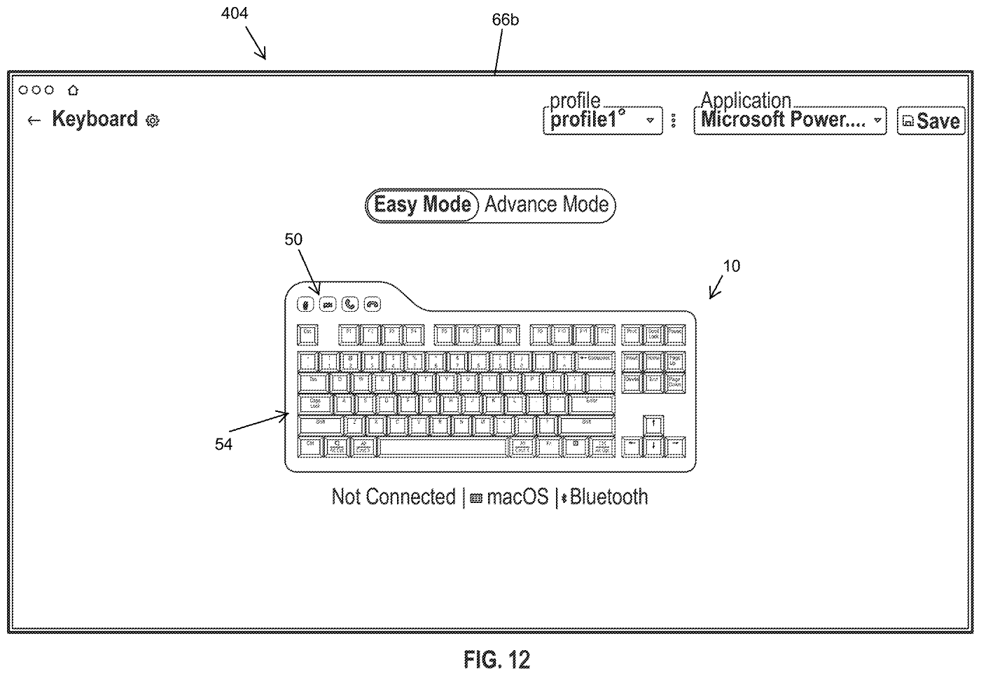

The electronic processor 38 is configured to receive instructions and data from the memory 400 and execute, among other things, instructions related to operation of the applications 66a-66c. In particular, the electronic processor 38 executes instructions stored in the memory 400 to perform the methods described herein. For example, in the embodiment illustrated in FIG. 8, the memory 400 includes a teleconferencing application 66a. Also, in some embodiments, the memory 400 includes an auxiliary application 66b that allows the electronic device 14 to communicate with the keyboard 10. In particular, the auxiliary application 66b enables the electronic device 14 to communicate with the keyboard 10 to program the switches 74, 148 of the keyboard 10 and communicate with and operate the teleconferencing application 66a as described herein. For example, in some embodiments, as shown in FIGS. 12-14, the auxiliary application 66b includes a browser application, such as Internet Explorer® provided by Microsoft Corporation, configured to communicate with the keyboard 10 as described herein. As will be discussed in greater detail below, when the electronic processor 38 receives the signals from the controller 26 of the keyboard 10, the electronic processor 38 is configured to receive instructions and data from the memory 400 and execute, among other things, instructions related to operation either or both of the teleconferencing and auxiliary applications 66a, 66b to perform functions on the electronic device 14.

The electronic device 14 may include additional components than those illustrated in FIG. 8 in various configurations and may perform additional functionality than the functionality described herein. For example, in some embodiments, the electronic device 14 includes multiple electronic processors, multiple memories, multiple communication interfaces, multiple output devices, or a combination thereof. Also, other input devices in addition to the keyboard 10 may also be used with the electronic device 14.

The keyboard 10 is operable in a first operational mode, a second operational mode, and a third operation mode.

In the first operational mode, each of the teleconferencing keys 54 are dedicated physical keys that operate the teleconferencing application 66a. In the illustrated embodiment, a first teleconferencing key 54 has a first function (e.g., is a dedicated “mute/unmute microphone” key that mutes and unmutes a microphone), a second teleconferencing key 54 has a second function (e.g., is a dedicated “camera on/off” key that turns a camera on or off), a third teleconferencing key 54 has a third function (e.g., is a dedicated “answer call/meeting” key that answers a call), and a fourth teleconferencing key 54 has a fourth function (e.g., is a dedicated “end call/meeting” key that ends a call). Each of these keys 54 may have relevant indicia that indicate the exact function thereof. The indicia may be permanently applied to the keys 54 via printing, etching, and the like.

While the teleconferencing application 66a is in the foreground of the electronic device 14 and viewable on the graphical user interface 404, actuation of the one of the teleconferencing keys 54 causes the actuation of a corresponding actuator 62a-62d (FIG. 9) of the teleconferencing application 66a. For example, when the first teleconferencing key 54 is actuated on the keyboard 10, the teleconferencing actuator 62a having the corresponding function is actuated. In this case, when the mute/unmute microphone key 54 is actuated on the keyboard 10, the mute/unmute microphone actuator 62a of the teleconferencing application 66a is actuated to mute or unmute the microphone.

More specifically, with respect to FIG. 10, moving each of the teleconferencing keys 54 on the keyboard 10 to the actuated position causes actuation of the corresponding switch 148 on the PCB 30 of the keyboard 10. When the corresponding switch 148 is actuated, the switch 148 is configured to generate a signal. In response, at operation 450, the controller 26 is configured to receive the signal. At operation 454, the controller 26 is configured to send the signal to the electronic processor 38 of the electronic device 14 to perform a function in a teleconferencing application of the electronic device 14 while the teleconferencing application is running in the foreground of the electronic device 38. The controller 26 is configured to send the signal to the electronic processor 38. In response to receiving the signal, the electronic processor 38 is configured to receive instructions and data from the memory 400 and execute, among other things, instructions to the teleconferencing application 66a to actuate the corresponding actuator 62a-62d of the teleconferencing application 66a.

In the context of the mute/unmute microphone key 54, for example, moving the mute/unmute microphone key 54 to the actuated position causes actuation of the corresponding switch 148 on the PCB 30 of the keyboard 10. When the corresponding switch 148 is actuated, the switch 148 is configured to generate a signal. In response, the controller 26 is configured to receive the signal from the switch 148 and send the signal to the electronic processor 38. In response to receiving the signal from the controller 26, the electronic processor 38 is configured to receive instructions and data from the memory 400 and execute, among other things, instructions to the teleconferencing application 66a to actuate the mute/unmute microphone actuator 66a of the teleconferencing application 66a. Therefore, actuating the physical mute/unmute microphone key 54 on the keyboard operably mutes or unmutes the microphone such that the user can be heard or silent within the teleconference.

In the second operational mode, the controller 26 of the keyboard 10 is configured to communicate with the auxiliary application 66b loaded onto the electronic device 14 and the teleconferencing application 66a. The auxiliary application 66b is operable to customize the teleconferencing keys 54 and standard keys 50. The auxiliary application 66b is also operable such that when one of the teleconferencing keys 54 is actuated, the corresponding actuator 62a-62d of the teleconferencing application 66a is actuated, whether the teleconferencing application 66a is in the foreground or the background of the electronic device 14. The third operation mode is similar to the second operational mode except that the standard keys 50 may also be customized using auxiliary application 66b.

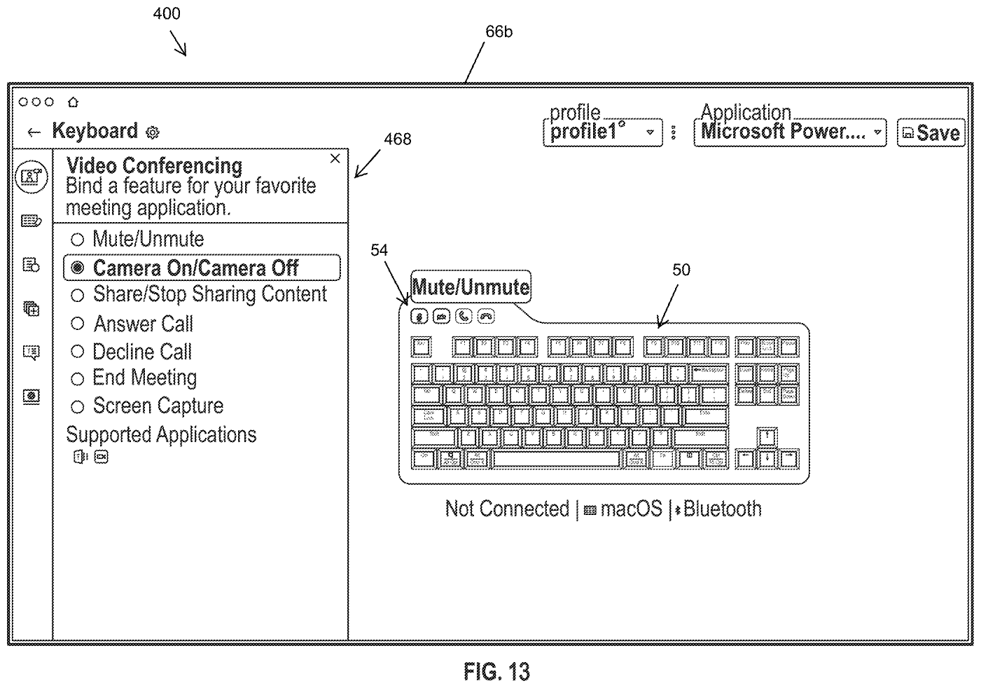

With respect to FIG. 12, at operation 460, the electronic processor 38 is configured to receive a signal. In some instances, the signal may be indicative of user input to the auxiliary application 66b. At operation 464, in response to receiving a user input signal, the electronic processor is configured to change a function of one of the plurality of physical teleconferencing keys from a first function to a second function. For example, the user may access the auxiliary application 66b via the graphical user interface 404 of the electronic device 14. As shown in FIG. 12, the application 66b may show a view of the keyboard 10 on the graphical user interface 404. As shown in FIG. 13, using a menu 468 displayed on the graphical user interface 404, the user may select one of the teleconferencing keys 54 and designate it as having one of a plurality of functions (e.g., a second function), which may be different the original function (e.g., a first function) of each of the teleconferencing keys 54 of the first operation mode. The plurality of functions may be a mute/unmute microphone function, a camera on/off function, a share/stop sharing content function, an answer call/meeting function, a decline call/meeting function, an end call/meeting function, or a screen capture function. In some embodiments, additional functions may also be available.

Moreover, with continued reference to FIG. 11 and operation 460, when the auxiliary application 66b is stored in memory 400, the electronic processor 38 is also configured to receive a signal from each of a plurality of physical teleconferencing keys 54 of a keyboard 10 when each of the plurality of physical teleconferencing keys 54 is actuated. At operation 472, in response to receiving a signal corresponding to actuation of the key 54, the electronic processor 38 is configured send the signal to a teleconferencing application 66a running on electronic device 14 while the teleconferencing application 66a is running in the foreground or the background of the electronic device 14, and actuate an actuator 62a-62d in the teleconferencing application 66a to perform a function. Accordingly, when the auxiliary application 66b is stored in the memory 400, whether the teleconferencing application 66a is in the foreground of the electronic device 14 and viewable in graphical user interface 404 or in the background of the electronic device 14 and hidden from the graphical user interface 404, actuation of the one of the teleconferencing keys 54 causes the actuation of a corresponding actuator 62a-62d of the teleconferencing application 66a.

With renewed reference to FIG. 10, the same operations for communication between the keyboard and the electronic device 14 apply when the auxiliary application 66b is in use as when it is not in use. That is, moving one of the teleconferencing keys 54 on the keyboard 10 to the actuated position causes actuation of the corresponding switch 148 on the PCB 30 of the keyboard 10. When the corresponding switch 148 is actuated, the switch 148 is configured to generate a signal. At operation 450, the controller 26 is configured to receive the signal from the switch 148 corresponding to one of the teleconferencing keys 54. At operation 454, the controller 26 is configured to send the signal to the electronic processor 38 to the electronic device 14 to perform a function in a teleconferencing application of the electronic device 14. This is the case whether the teleconferencing application 66a is running in the foreground or the background of the electronic device 38. In response to receiving the signal from the keyboard 10, the electronic processor 38 operates as noted above with respect to FIG. 11. That is, the electronic processor 38 receives instructions and data from the memory 400 and executes, among other things, instructions to the teleconferencing application 66a to actuate the corresponding actuator 62a-62d of the teleconferencing application 66a.

In the context of the mute/unmute microphone key 54, for example, moving the mute/unmute microphone key 54 to the actuated position causes actuation of the corresponding switch 148 on the PCB 30 of the keyboard 10. When the corresponding switch 148 is actuated, the switch 148 is configured to generate a signal. The electronic processor 38 is configured to receive the signal from the controller 26 of the keyboard 10. Accordingly, the electronic processor 38 is configured to receive instructions and data from the memory 400 and execute, among other things, instructions to the teleconferencing application 66a to actuate the mute/unmute microphone actuator 66a of the teleconferencing application 66a even if the teleconferencing application is running in the background. Therefore, actuating the physical mute/unmute microphone key 54 on the keyboard operably mutes or unmutes the microphone such that the user can be silent or mute within the teleconference application regardless of whether the teleconference application 66a is in the foreground or the background. Simply put, if one of the teleconferencing keys 54 is designated as the mute/unmute microphone key and the user is listening to a teleconference with the microphone muted, the user can actuate the mute/unmute microphone key 54 to actuate the mute/unmute microphone actuator 62a of the teleconferencing application 66a to quickly unmute themselves even if the user is working in another application.

The electronic processor 38 is also configured to bring the teleconferencing application 66a to the foreground of the electronic device 14, if the teleconferencing application 66a is in the background. That is, actuation of one of the teleconferencing keys 54 will automatically cause the teleconferencing application 66a to be brought to the foreground and the corresponding actuator 62a-62d of the teleconferencing application 66a to be actuated.

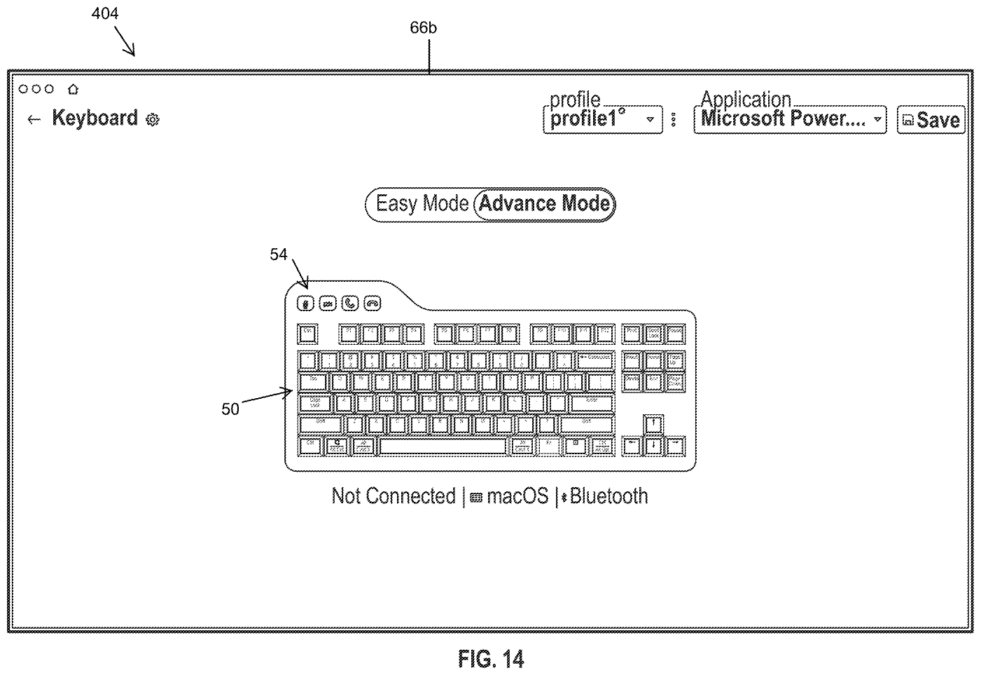

As shown in FIG. 14, when in the third operational mode the user may select any one of the teleconferencing keys 54 or the standard keys 50 and designate it as having one of a plurality of functions. Operation of the standard keys is generally the same as the operation of the teleconferencing keys 54, discussed above and shown in FIG. 10.

Various features and advantages of the invention are set forth in the following claims.

What is claimed is:

1. A keyboard for use with an electronic device including an electronic processor, the keyboard comprising:
a printed circuit board that is configured to communicate with the electronic processor of the electronic device;
a first plurality of physical keys, each of the first plurality of physical keys being movable between an unactuated position and an actuated position, when in the actuated position each of the first plurality of physical keys is configured to generate a first signal that inserts a character on the electronic device; and
a second plurality of dedicated physical keys, each of the second plurality of dedicated physical keys being movable between an unactuated position and an actuated position, when in the actuated position each of the second plurality of dedicated physical keys is configured to generate a second signal that performs a function in a teleconferencing application running on the electronic device.

2. The keyboard of claim 1, wherein the second plurality of dedicated physical keys includes one or more selected from a group consisting of a mute/unmute microphone key, a camera on/off key, an answer call/meeting key, and an end call/meeting.

3. The keyboard of claim 2, wherein
when the mute/unmute microphone key is moved to the actuated position, the mute/unmute microphone key is configured to actuate a mute/unmute microphone actuator of the teleconferencing application,
when the camera on/off key is moved to the actuated position, the camera on/off key is configured to actuate a camera on/off actuator of the teleconferencing application,
when the answer call/meeting key is moved to the actuated position, the answer call/meeting key is configured to actuate an answer actuator of the teleconferencing application, and
when the end call/meeting key is moved to the actuated position, the end call/meeting key is configured to actuate an end call/meeting actuator of the teleconferencing application.

4. The keyboard of claim 2, wherein
when the mute/unmute microphone key is moved to the actuated position, the mute/unmute microphone key is configured to generate and send the second signal to the teleconferencing application to mute or unmute a microphone,
when the camera on/off key is moved to the actuated position, the camera on/off key is configured to generate and send the second signal to the teleconferencing application to turn a camera on or off,
when the answer call/meeting key is moved to the actuated position, the answer call/meeting key is configured to generate and send the second signal to the teleconferencing application to answer a teleconference call, and
when the end call/meeting key is moved to the actuated position, the end call/meeting key is configured to generate and send the second signal to the teleconferencing application to end a teleconference call.

5. The keyboard of claim 1, wherein the first plurality of physical keys is organized into six rows and the second plurality of dedicated physical keys is organized into a separate row that is spaced apart from a top-most row of the six rows.

6. The keyboard of claim 1, wherein the second plurality of dedicated physical keys each include a key cap that is configured to move the switch from unactuated position to the actuated position.

7. The keyboard of claim 1, wherein each of the first plurality of physical keys and the second plurality of dedicated physical keys includes a key cap that is configured to actuate a switch that is supported by the printed circuit board, and the keyboard further comprising an elastic member positioned between the key caps and the printed circuit board.

8. The keyboard of claim 7, wherein the elastic member includes a plurality of apertures, and wherein at least a portion of each of the switches associated with the first plurality of physical keys is configured to extend through one of the plurality of apertures of the elastic member.

9. The keyboard of claim 7, further comprising a housing enclosing the elastic member, the printed circuit board, and the switches, the housing including a bottom wall having a drain aperture extending therethrough, and wherein the elastic member includes a surface that guides fluid to the drain aperture.

10. The keyboard of claim 7, wherein the key cap of each of the first plurality of physical keys contacts the elastic member to move the corresponding switch to the actuated position.

11. A keyboard for use with an electronic device, the electronic device including an electronic processor, the keyboard comprising:
a printed circuit board including a controller; and
a plurality of physical teleconferencing keys, each of the plurality of physical teleconferencing keys being movable between an unactuated position and an actuated position, in the actuated position each of the plurality of physical teleconferencing keys is configured to generate a signal;
wherein the controller is configured to
receive the signal from each of the plurality of physical teleconferencing keys when each of the plurality of physical teleconferencing keys is actuated, and
send the signal to the electronic device to perform a function in a teleconferencing application of the electronic device while the teleconferencing application is running in a background of the electronic device.

12. The keyboard system of claim 11, further comprising a plurality of physical standard keys, each of the plurality of physical standard keys being movable between an unactuated position and an actuated position, in the actuated position each of the plurality of physical standard keys is configured to generate a first signal, and wherein the controller is configured to
receive the first signal from each of the plurality of physical teleconferencing keys when each of the plurality of physical standard keys is actuated, and
send the first signal to the electronic device to input a character onto the electronic device.

13. The keyboard system of claim 11, wherein each of the plurality of teleconferencing keys includes a key cap that is configured to move a corresponding switch from the unactuated position to the actuated position.

14. A non-transitory, computer-readable medium storing instructions that, when executed by an electronic processor, perform a set of functions, the set of functions comprising:
receiving a signal from a plurality of physical teleconferencing keys of a keyboard when each of the plurality of physical teleconferencing keys is actuated;
sending the signal to a teleconferencing application running on electronic device while the teleconferencing application is running in a background of the electronic device; and
actuating a function in the teleconferencing application associated with the actuated physical teleconferencing key.

15. The non-transitory, computer-readable medium of claim 14, wherein the set of functions further comprises causing the teleconferencing application to be brought to a foreground of the electronic device.

16. The non-transitory, computer-readable medium of claim 14, wherein the set of functions further comprises receiving a user input and, in response to receiving the user input, changing the function associated with one of the plurality of physical teleconferencing keys from a first function to a second function.

17. The non-transitory, computer-readable medium of claim 16, wherein the first function is a mute/unmute microphone function, a camera on/off function, an answer call/meeting function, or an end call/meeting function, and wherein the second function is a mute/unmute microphone function, a camera on/off function, a share/stop sharing content function, an answer call/meeting function, a decline call/meeting function, an end/meeting function, or a screen capture function.

18. A keyboard for use with an electronic device, the keyboard comprising:
a housing including
a first housing portion, and
a second housing portion coupled to the first housing portion;
a switch support positioned within the housing, the switch support including a plurality of apertures extending therethrough;
a printed circuit board supported by the switch support and accessible via the plurality of apertures of the switch support;
a plurality of switches supported by the switch support, each of the plurality of switches accessible through one of the plurality of apertures in the switch support and including a contact pin in contact with printed circuit board; and
an elastic member supported by the switch support, the elastic member including a plurality of openings, each of the plurality of openings corresponding to one of the plurality of apertures in the switch support, and
a plurality of key caps, each key cap including a shell and a projection extending from the shell through the first housing portion, the projection of each key cap engaging one of the plurality of switches to move the switch between an unactuated position, in which the contact pin is not in communication with the circuit board, and an actuated position, in which the contact pin is in communication with the printed circuit board,
wherein a portion the elastic member is positioned between each of switch and the shell of each key cap to inhibit fluid from contacting the printed circuit board and to reduce a sound emitted when the shell of each key cap moves to the actuated position.

19. The keyboard of claim 18, wherein the second housing portion includes a first drain hole and the elastic member includes a second drain hole that is in fluid communication with the first drain hole to guide fluid from the elastic member through the second housing portion without contacting the printed circuit board.

20. The keyboard of claim 18, wherein the plurality of switches includes a first plurality of switches configured to generate first signal that input characters on the electronic device and a second plurality of switches configured to generate second signal that perform functions in a teleconferencing application running on the electronic device.

21. The keyboard of claim 20, wherein the second plurality of switches includes one or more selected from a group consisting of a mute/unmute microphone key, a camera on/off key, an answer call/meeting key, and an end call/meeting key.

22. The keyboard of claim 20, wherein the first plurality of switches is organized into six rows and the second plurality of switches is organized into a separate row that is spaced apart from a top-most row of the six rows.
